(19) United States
(12) Patent Application Publication
(10) Pub. No.: US 2014/0301593 A1
(43) Pub. Date: Oct. 9, 2014

(54) Speaker Acoustic Chamber for Electronic Device Cover

(71) Applicant: Robert James Shannon, III, Clermont, FL (US)

(72) Inventor: Robert James Shannon, III, Clermont, FL (US)

(21) Appl. No.: 13/859,632

(22) Filed: Apr. 9, 2013

(51) Int. Cl. H04R 1/02

(52) U.S. Cl. CPC H04R 1/028
USPC 381/386

(57) ABSTRACT

The invention is a chamber within the cover applied to an electronic device which, by way of its design, channels the flow of sound and re-directs the sound emanating from the speaker, or speakers, of the device. The design characteristics of this chamber may facilitate the flow and direction of sound, and may provide acoustical enhancement of the sound to the user of the electronic device, to which said cover has been applied.

### BACKGROUND

### 1. Field of the Invention

The present invention relates to the field of electronic devices. Specifically, the invention relates to a chamber designed within a cover applied to said electronic device, through which sound will pass and be directed. This unique design may direct sound from the speaker unit of said electronic device toward the user of the device.

2. Related Art

An electronic device, such as a computer tablet, may have speakers incorporated within it's structure which emit and disburse sound in various directions. Therefore, there is room for improvement within the art of electronic device cover design for enhancement of sound.

### SUMMARY OF THE INVENTION

A speaker acoustic chamber design is disclosed. The design of said chamber may provide acoustic capabilities by changing the direction of the sound path which emanates from the speaker of the electronic device, to pass through the cover which has been applied to the electronic device. By this re-direction, the sound may be amplified and may be acoustically enhanced toward the user of said device.

### DETAILED DESCRIPTION OF THE INVENTION

An exemplary design for an acoustic chamber is disclosed, as per the illustrations provided.

Electronic devices may have speaker units incorporated within their structure which emit and disburse sound in various directions. Electronic devices may also have covers applied to them for decorative or protective purposes. While the electronic device has these covers applied, there may be an opportunity for the enhancement of sound emitting from the device.

The unique design of said speaker acoustic chamber may include a channel which, by way of its design, re-directs the flow of sound emitting from the device. This chamber is primarily a formed passageway through which sound flows. This channeling process within the chamber may facilitate the transfer of sound and promote the direction of sound toward the listener of the electronic device. The design may benefit the listener of said device by providing some acoustical enhancement while said device cover has been applied.

Aspects of the unique design of said acoustic chamber may include variations in size, depth, position, structure, and direction of flow of said channel through which the sound passes. These variations may be based on the speaker positions on the various electronic devices, and on other particular design aspects of the covers applied to these devices, including style formations, protective features, etc.

Such speaker acoustic chambers may be applied to electronic device covers, or covers of other devices, which may benefit from an enhancement or re-direction of sound. The present invention is described primarily in the context of electronic devices. Possible examples of said electronic devices include, but are not limited to; computer tablets, communication devices, electronic readers, etc. The present invention can be implemented in numerous and various electronic devices covers.

It is to be understood, however, that even though numerous characteristics and advantages of the exemplary invention have been set forth in the foregoing description and illustrations, the disclosure is illustrative only. It is further understood, that changes may be made in detail, especially in matters of shape, size, structure, depth of chamber, within the principles of the invention, to the full extent indicated by the broad general meaning of the terms in which the claim is expressed.

### DESCRIPTION OF VIEWS OF THE DRAWINGS

FIG. 1 Front View of cover containing Speaker Acoustic Chamber

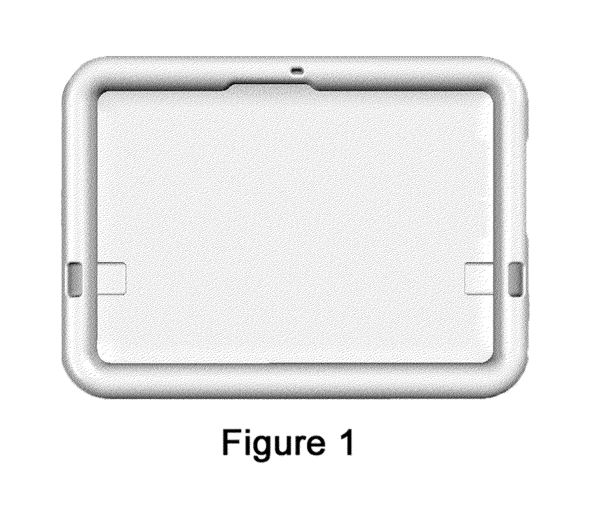

FIG. 2 Angled Front View of cover containing Speaker Acoustic Chamber

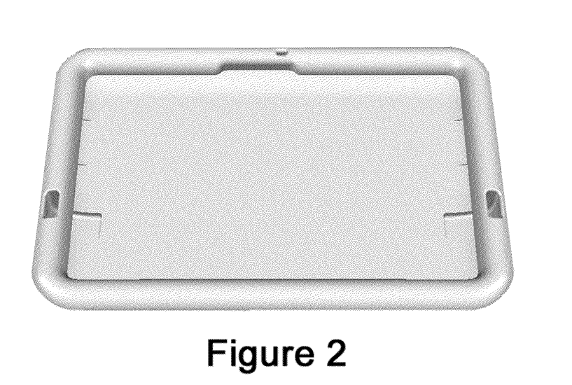

FIG. 3 Front View of Speaker Acoustic Chamber

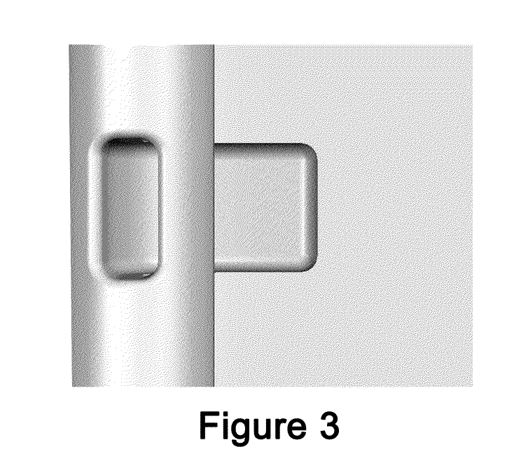

FIG. 4 Interior View of Speaker Acoustic Chamber

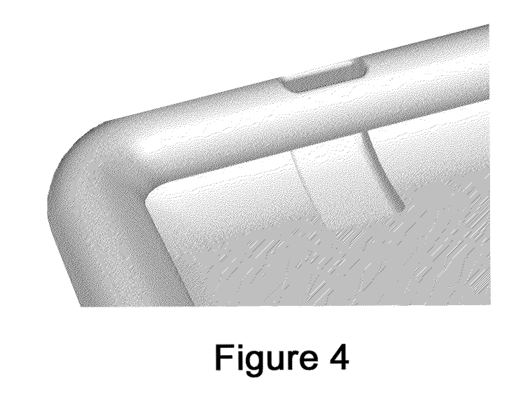

FIG. 5 Exterior Back View of Speaker Acoustic Chamber

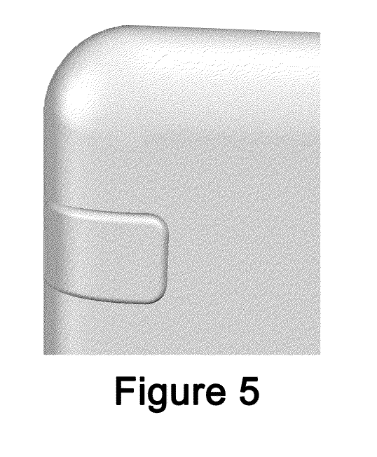

FIG. 6 Exterior Side View of Speaker Acoustic Chamber

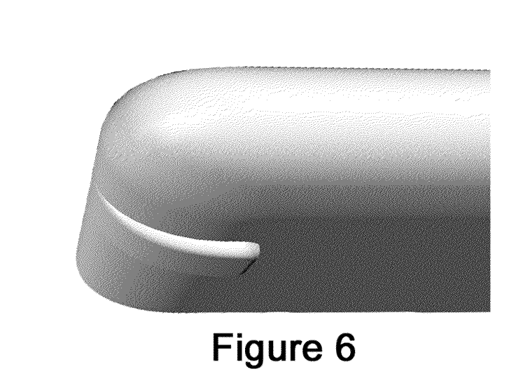

FIG. 7 Cross Section of Speaker Acoustic Chamber

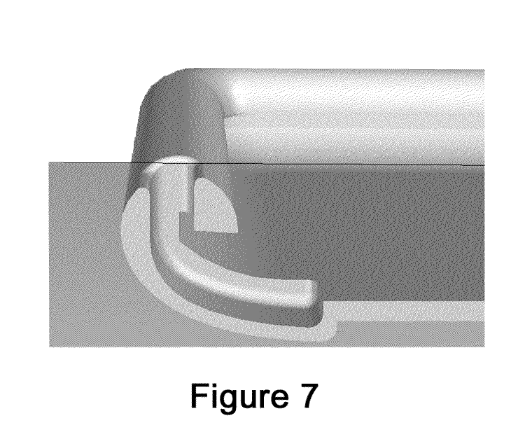

FIG. 8 Angled Cross Section of Speaker Acoustic Chamber

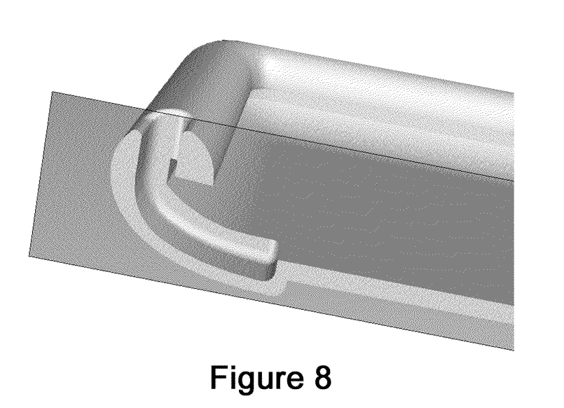

1. We claim the design for a speaker acoustic chamber for an electronic device cover, as shown and described.
